(19) United States
(12) Patent Application Publication
(10) Pub. No.: US 2017/0178625 A1
(43) Pub. Date: Jun. 22, 2017

(54) SEMANTIC WORD AFFINITY AUTOMATIC SPEECH RECOGNITION

(71) Applicants: Jonathan Mamou, Jerusalem (IL); Moshe Wasserblat, Maccabim (IL); Oren Pereg, Amikam (IL); Michel Assayag, Shoham (IL); Orgad Keller, Tel Aviv (IL)

(72) Inventors: Jonathan Mamou, Jerusalem (IL); Moshe Wasserblat, Maccabim (IL); Oren Pereg, Amikam (IL); Michel Assayag, Shoham (IL); Orgad Keller, Tel Aviv (IL)

(21) Appl. No.: 14/976,809

(22) Filed: Dec. 21, 2015

(51) Int. Cl. G10L 15/18; G10L 15/26; G10L 15/10; G10L 15/197

(52) U.S. Cl. CPC G10L 15/1815; G10L 15/197; G10L 15/26; G10L 15/10

(57) ABSTRACT

System and techniques for direct motion sensor input to rendering pipeline are described herein. A ranked list of ASR hypotheses may be obtained. A set of ASR hypotheses may be selected from the list. The set of ASR hypothesis may be re-ranked using semantic coherence scoring between words in the ASR hypotheses. An ASR hypothesis from the set of ASR hypotheses with a highest re-rank may be outputted.

### TECHNICAL FIELD

Embodiments described herein generally relate to automatic speech recognition (ASR) and more specifically to semantic word affinity enhanced ASR.

### BACKGROUND

ASR attempts to automatically understand human speech for a variety of applications. Generally, an ASR engine applies a variety of voice model techniques to develop one or more hypotheses of words corresponding to spoken language. Often, the best hypothesis is chosen among an N-best list generated from a lattice using acoustic and language models. The ASR engine then may provide the 1-best hypothesis (e.g., the highest ranked hypothesis) to a Spoken Language Understanding (SLU) engine to, for example, enact the intent of a user's utterance (e.g., voice control of a device).

A language model provides context to the ASR engine to distinguish between words and phrases that sound similar. However, data sparsity may be a challenge in building language models. Many possible word sequences will not be observed in training. A classical solution is to generate an n-gram language model by making the assumption that the probability of a word (e.g., gram) only depends on the previous n words. English language models typically employ a 3-gram model. N-gram language models are common because they provide excellent modeling power while being fast to train and easy to compile into finite state transducer (FST) decoders.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a block diagram of an example of a system including a component for semantic word affinity ASR, according to an embodiment.

FIG. 2 illustrates an example of a flow for semantic word affinity ASR, according to an embodiment.

FIG. 3 illustrates an example of a flow for semantic word affinity ASR, according to an embodiment.

FIG. 4 illustrates an example of a method for semantic word affinity ASR, according to an embodiment.

FIG. 5 is a block diagram illustrating an example of a machine upon which one or more embodiments may be implemented.

### DETAILED DESCRIPTION

The n-gram modeling discussed above does have some drawbacks. In some instances, because of the limited language context they model, n-gram language models may output ungrammatical or implausible word sequences. For instance, given an utterance, “wait so you're saying next >>Tuesday<< is it the whole group >>meeting<< or just,” an n-gram model may produce the following hypothesis, “with using >>extra stares<< at the hall great >>meeting<< are just,” the words contained between “>>” and “<<” representing extracted keyphrases. The table below shows an example of the best hypothesis distribution at different rank positions in a 50-best hypotheses list. Notably, only 33% of the utterances have their best hypothesis in the 1-best while 41% of the utterances have their best hypothesis after the 5-best.

| rank position | % best hypothesis |
|---|---|
| 1 | 33 |
| 2 | 11 |
| 3 | 7 |
| 4 | 4 |
| 5 | 4 |
| 6+ | 41 |

To address some of the shortcoming in the current linguistic models for ASR while continuing to leverage the efficiency in training and using these models, a semantic scoring of words in ASR generated hypotheses may be used. Specifically, a set of generated ASR hypotheses for speech are generated and ranked in a typical manner (e.g., using an n-gram language model). This set of hypothesis are then re-ranked using semantic coherence (e.g., relatedness) scoring between words in the respective hypothesis. In an example, the highest re-ranked hypothesis is selected as the hypothesis to be, for example, used by an SLU engine.

To perform the semantic scoring, a number of statistical or machine learning mechanisms may be used. For example, word semantics may be modeled in a distributional vector space representing co-occurrence. In these models, words are represented (e.g., stored) as vectors recording word co-occurrence counts with context elements in a corpus (e.g., body of text such as an encyclopedia, all known books, etc.). For example, given the two sentences “Who says that cats and dogs don't get along?” and “Look how some cats and kittens play with dogs and annoy them,” we can see that in both sentences “dog” and “cat” appeared once, leading to a dog vector of [1, 1] (a dimension for each document) and a cat vector of [1, 1]. In these applications, the vectors capture “semantics,” with the dimensionality being the size of the vocabulary. The geometric relationship between the vectors of two words indicates how similar in meaning that two words are. Thus, the semantic similarity of “dog” and “cat” may be represented as:

$$sim ( \vec{dog} , \vec{cat} ) = \frac{\vec{dog} ∘ \vec{cat}}{‖ \vec{dog} ‖ ‖ \vec{cat} ‖}$$

In distributional space, word vectors often range from tens of thousands to millions of context dimensions that are often sparse. A variety of techniques may be employed to reduce the dimensionality of this space and make the resulting data structure easier to use. For example, the word2vec algorithm may be used to produce a semantic model with word vectors of real numbers and low dimensional space relative to vocabulary size. Word2vec employs a shallow perceptron (e.g., two-layer) to create the vectors based on continuous-bag-of-words and skip-gram architectures. However, any semantic model may be used that provides a score between concepts in an ASR hypothesis that may be compared against a score in another ASR hypothesis.

Using this mechanism, ASR hypothesis may be re-ranked using semantic analysis to arrive at an improved result. Again, given the utterance, “wait so you're saying next >>Tuesday<< is it the whole group >>meeting<< or just,” an n-gram model may produce several hypothesis, including the following hypotheses: 1) “with using >>extra stares<< at the hall great >>meeting<< are just;” and 9) “with using >>next Tuesday<< is it that whole great >>meeting<< or just.” Based on the original ASR ranking, the first hypothesis would be chosen. However, the words in the keyphrases are subjected to semantic coherence scoring, producing the following example results (the right hand of the table being an inverse of the geometric distance between the words pairs in the row):

Hypothesis 1 Semantic coherence

| | | |
|---|---|---|
| extra | stares | 0.01 |
| extra | meeting | 0.04 |
| stares | meeting | 0.07 |

Hypothesis 9 Semantic coherence

| | | |
|---|---|---|
| next | Tuesday | 0.16 |
| next | meeting | 0.13 |
| Tuesday | meeting | 0.17 |

Thus, under semantic coherence analysis, it is clear that the ninth hypothesis is better than the first hypothesis, a result reflected in the re-ranking of the set of hypothesis. Using the re-ranked hypothesis results in a lower word-error-rate (WER) or higher word detection rate than not using them. Experimentally, using 300 dimensional vectors over three million words applied to more than 200 utterances, WER and the detection rate were improved by around three percent over standard ASR analysis.

Word embedding (e.g., distributional vector space representing co-occurrence) attempts to understand meaning and semantic relationships among words. It works in a way that is similar to deep approaches, such as recurrent neural networks or deep neural networks, but is computationally more efficient. Two different scoring functions may be used to produce semantic coherence scoring using the described word embedding techniques:
1. Given a hypothesis, evaluate its semantic coherence by computing the semantic relatedness of the terms of the hypothesis, known as intra-hypothesis semantic coherence (illustrated above).
2. Given a hypothesis, evaluate its semantic coherence by computing the conversation-hypothesis word2vec semantic relatedness, known as hypothesis-context semantic coherence.
   Whether either approach is applied, the result is a better performing ASR engine without resorting to computationally expensive techniques. Additional details are discussed below.

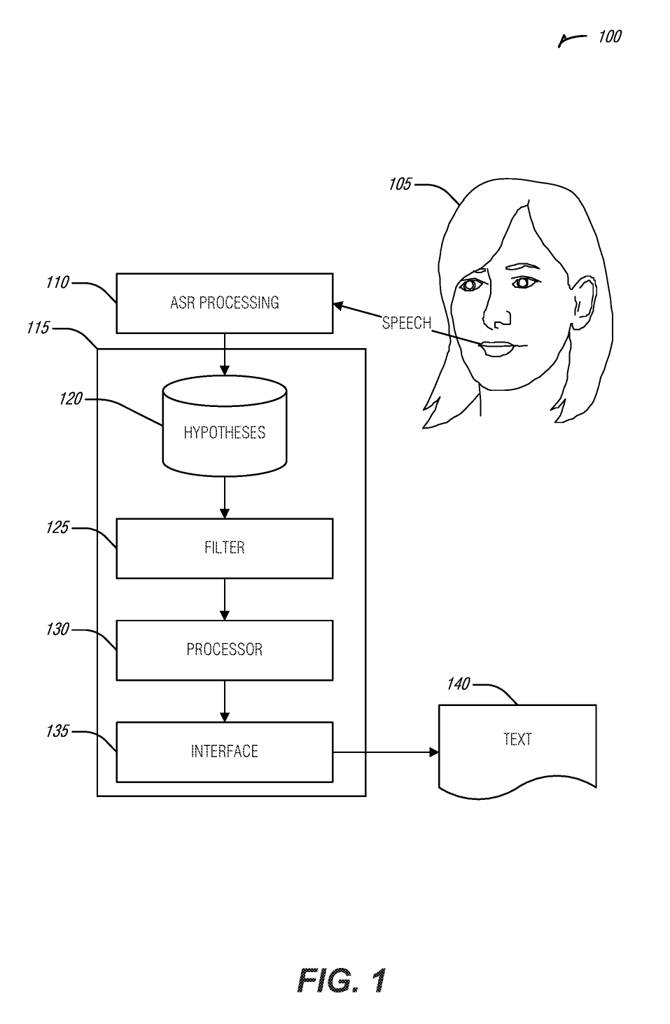

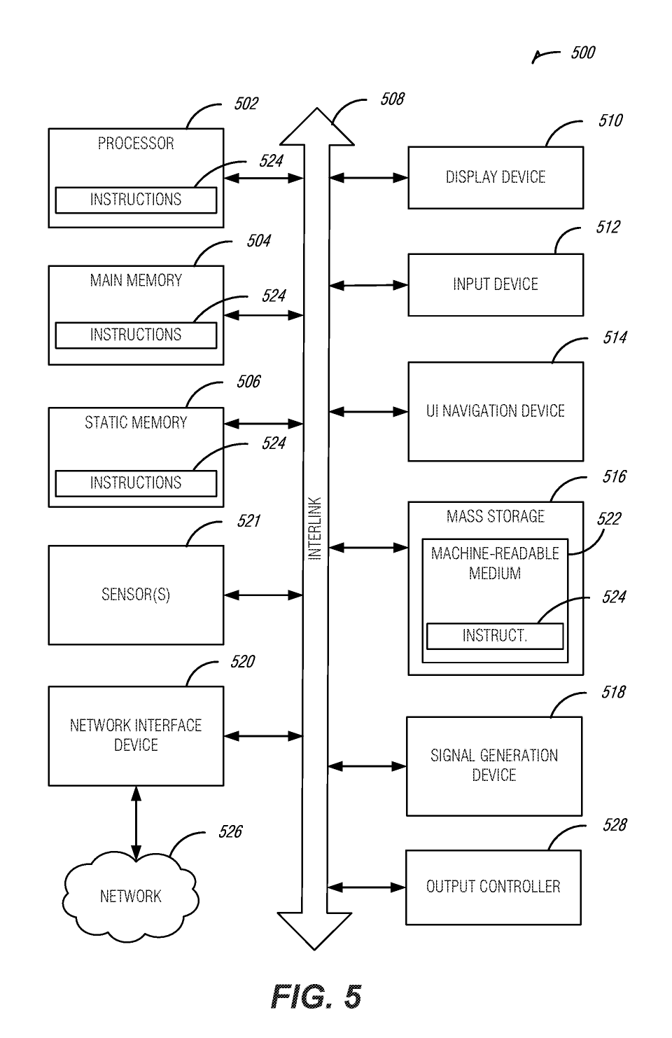

FIG. 1 is a block diagram of an example of a system 100 including a component for semantic word affinity ASR 115, according to an embodiment. The system 100 may include an ASR processing block 110 and includes the component 115. Both the ASR processing block 110 and the component 115 are implemented in computer hardware (e.g., processors, circuits, memory, circuit sets, etc.) such as that described below with respect to FIG. 5.

The ASR processing block 110 operates as a classical ASR engine to use acoustic information and the statistical word n-gram information to create a ranked list of hypothesis for a given utterance from the user 105. Typically, the ASR block 110 is arranged to produce a list of n hypotheses per time interval t. In an example, a hypothesis is a sentence which is comprises a string of words that represent an uttered sentence measureable in a speech signal from the user 105 at time interval t. This list of hypothesis is ranked. The higher the rank, the higher the probability that the hypothesis is correct. A “correct” word, in this case, means that the word was indeed uttered by the user 105. The ranking is based on available acoustic information from the speech signal and statistical word n-gram information.

As noted above, the component 115 re-ranks the produced hypotheses of the ASR block 110 to improve ASR performance. The component 115 includes a storage device 120, a filter 125, a processor 130, and an interface 135, and outputs text 140 of the re-ranking.

The storage device 120 is arranged to hold the ranked list of ASR hypotheses obtained from the ASR block 110. As noted above, in an example, the ranked list of ASR hypothesis are ranked by at least one of an acoustical model or a statistical n-gram model. In an example, a single gram in the n-gram model is a word.

The filter 125 is arranged to select a set of ASR hypotheses from the list in the storage device 120. In an example, the set of ASR hypotheses consists of a predefined number of the highest ranked ASR hypotheses from the list. For example, the predefined number may be ten, and thus the list will be the ten highest ranked hypothesis produced by the ASR processing block 110.

The processor 130 is arranged to re-rank the set of ASR hypothesis using semantic coherence scoring between words in the ASR hypotheses. In an example, to use the semantic coherence scoring, the processor 130 is arranged to apply a semantic model to words in an ASR hypothesis to produce a respective semantic score. The semantic model provides a mechanism by which to estimate semantic content based on a language. In an example, the semantic model is trained from textual data. In an example, training the data is the same that was used to create the language model used by the ASR block 110.

In an example, the processor 130 extracts keyphrases from the ASR hypothesis and applies the semantic model to the keyphrases to produce the respective semantic score. This technique may help focus the semantic analysis. Keyphrases may be based on parsing techniques, such as word type, word order, parts of speech, or other mechanisms designed to identify pertinent portions of text. In an example, the processor 130 is arranged to transform the extracted keyphrases to respective conical forms. These conical forms adhere to the semantic model. Thus, the processor 130 may apply the semantic model to the respective conical forms to produce the respective semantic score. Such preprocessing of the hypothesis text may simply semantic model creation, or increase computational efficiency of the model.

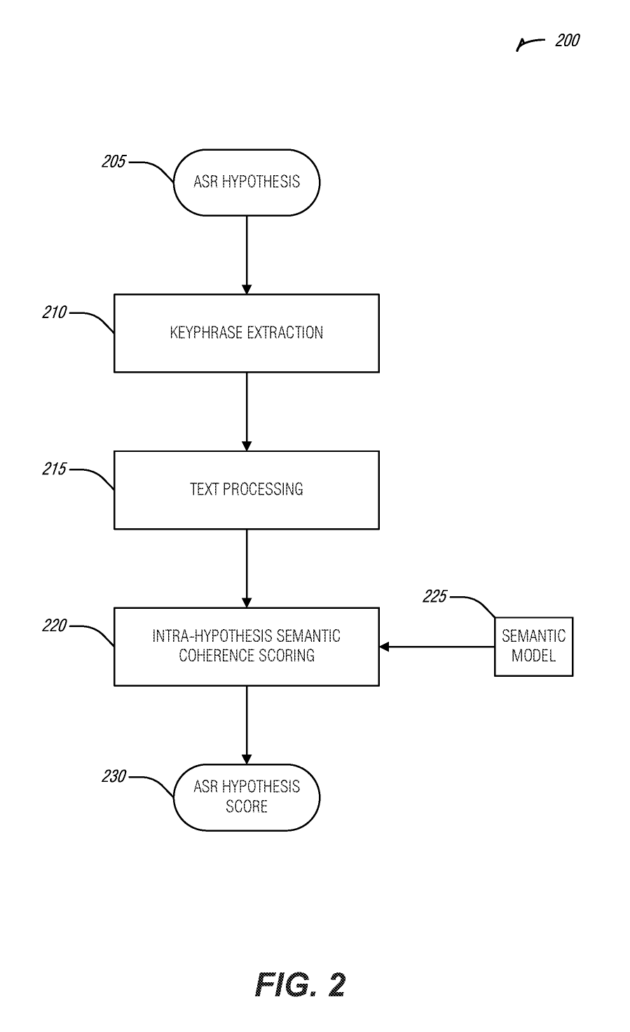

In an example, the semantic model comprises a set of word vectors. Each word of the model's vocabulary is represented as a vector, perhaps called a “word vector.” As noted above, the word2vec technique provides an efficient implementation of the continuous bag-of-words and skip-gram architectures for computing word vectors. In an example, the processor 130 is arranged to apply the semantic model by a distance between word vectors of words in a hypothesis and ranking the hypothesis higher when the distance is small. In an example, the distance computed is the cosine distance between the word vectors. In an example, the processor 130 is arranged to averaging distances between word vectors in keyphrases extracted from the hypothesis. Thus, as demonstrated above, the affinity between all of the keyphrase words are measured and averaged to arrive at the semantic coherence score for the entire hypothesis. An example of this technique is described below with respect to FIG. 2.

In an example, in addition to semantic coherence scoring based entirely on the information within each hypothesis, other hypothesis from the corpus, such as additional sentences in a conversation, may also play a part in the semantic coherence scoring for each later hypothesis. Thus, the processor 130 may be arranged to produce a context semantic score, using the semantic model, from a context of the hypothesis. The context may include one or more previously accepted hypothesis in a corpus that includes the hypothesis. Again, for example, a previously accepted hypothesis (e.g., sentence) in a conversation (e.g., corpus) with the user is just such a hypothesis in the corpus. In an example, the context includes a plurality of hypothesis selected from the corpus based on a predefined portion of speech. In an example, the predefined portion of speech is at least one of a paragraph, a window of sentences, or a conversation.

The processor 130 is arranged to combine the context semantic score and the respective semantic score. In an example, the context semantic score and the respective semantic coherence score are respective weighted sums of word vectors of the semantic model for words respectively present in the context semantic score and the respective semantic score. In an example, the processor 130 is arranged to compute the distance between the respective weighted sums of word vectors. Again, a smaller distance corresponds to a higher rank for the hypothesis. By combining the results of individual hypothesis semantic coherence and the semantic coherence with the corpus, the conversation itself provides clues to the intended words in an utterance. For example, if the conversation centers around a plan for a wedding in June, it is unlikely that the user 105 meant “sledding” in reference to a popular hill in a park used for such a purpose. Thus, “sledding” may be appropriate in to the single sentence, but discovered as inappropriate within the context of the conversation.

The interface 135 is arranged to output the re-ranked hypotheses in a textual form (e.g., text 140). In an example, the interface 135 is arranged to select a subset of the re-ranked hypotheses for the output 140. In an example, the subset is selected based on having a higher re-ranking. In an example, the interface 135 is arranged to output the highest re-ranked ASR hypothesis from the set of ASR hypotheses.

FIG. 2 illustrates an example of a flow 200 for semantic word affinity ASR, according to an embodiment. The actions in the flow 200 are performed on computer hardware, such as that described above with respect to FIG. 1 or below with respect to FIG. 5 (e.g., circuit sets). As noted above, this technique may be referred to as intra-hypothesis semantic coherence. An ASR engine produces an ASR hypothesis (start 205).

A keyphrase extraction (action 210) produces a list of keyphrases from the hypothesis. The keyphrases capture the important textual parts of the ASR hypothesis. As noted above, the “important” parts may be determined in a variety of ways, including confidence scoring from the original hypothesis for a given word, word type, word position in a sentence, or other relevant natural language processing metrics. A text processor may be used to further refine the hypothesis. For example, the text processor may apply a transformation to the extracted keyphrases, putting them into a canonical form matching the semantic model 225 (action 215).

The semantic model 225 may be applied to the preprocessed extracted keyphrases (action 220). A semantic coherence scorer may compute a global semantic coherence score of the whole ASR hypothesis, not just for a given keyphrase. For example, the semantic coherence score may be estimated by the average pairwise cosine distance between the word vectors of the extracted preprocessed keyphrases. That is, the distance between each pair of keywords in the keyphrases are average, the result representing the semantic coherence score for the whole hypothesis.

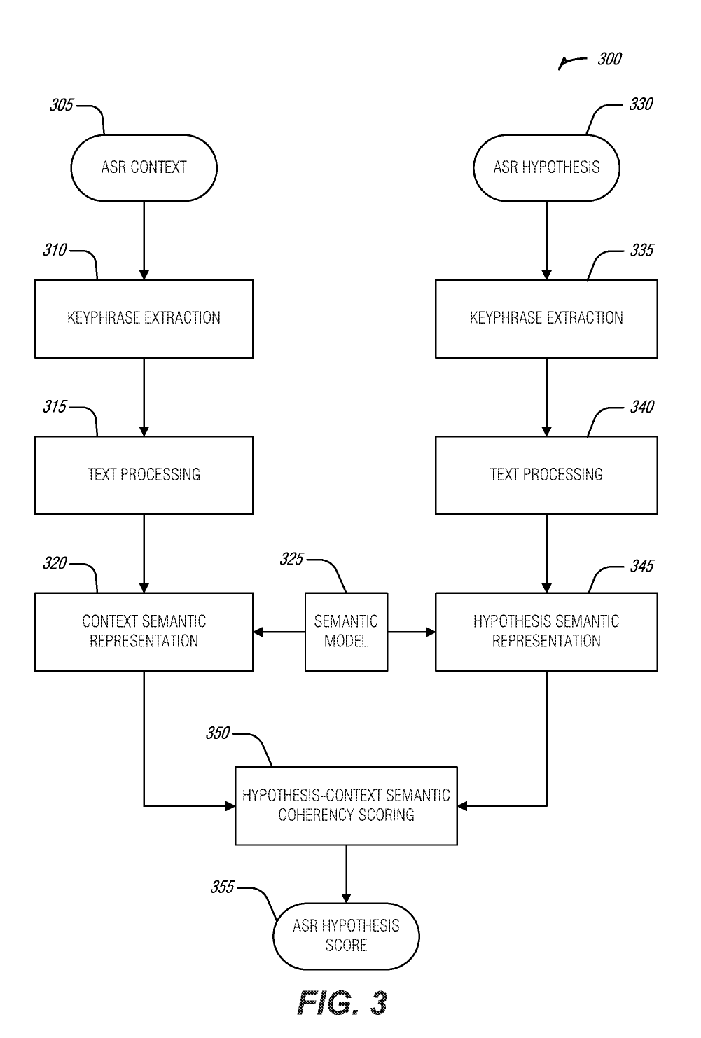

FIG. 3 illustrates an example of a flow 300 for semantic word affinity ASR, according to an embodiment. The actions in the flow 300 are performed on computer hardware, such as that described above with respect to FIG. 1 or below with respect to FIG. 5 (e.g., circuit sets). As noted above, this technique may be referred to as hypothesis-context semantic coherence.

As a brief overview, the right path of the flow 300 is similar to that described above with respect to FIG. 2. The left path of the flow 300, however, incorporates the context into the analysis. The results of both the left and right sides are combined to produce the semantic coherence score for the target hypothesis.

Given the ASR hypothesis 330, the ASR context 305 may also be identified. In an example, the context 305 may be defined as the whole document or conversation or part of it (paragraph, windows of few sentences before and after, etc.). As noted above, on the right hand side of the flow 300, for the ASR hypothesis 330, keyphrases may be extracted (action 335), the extracted keyphrases may be processed, for example, to put into a better form for the semantic model 325 (action 340) and a hypothesis-specific semantic representation (e.g., score) may be made (action 345). The semantic representation may be estimated by a weighted sum of the word vectors of the extracted preprocessed keyphrases of the hypothesis.

For the left side of the flow 300, instead of the single hypothesis 330, the process is performed on the context 305. Thus, given the semantic model 325 and the preprocessed (action 315) keyphrases (action 310) of the ASR context 305, the semantic representation of the context 305 is built (action 320). For example, this semantic representation may be estimated by a weighted sum of the word vectors of the extracted preprocessed keyphrases of the context (action 320). The weighting may include enhancing the impact of keyphrases that are closer in time to the ASR hypothesis 330, or enhancing the impact of words or keyphrases based on the word type, part of speech, etc.

The context and the hypothesis semantic representations are then combined (action 350) to create the ASR hypothesis score 355. The combination of these two representations may be estimated, for example, by computing the cosine distance between word vectors in the content and the hypothesis semantic representations. That closer together these word vectors are, the closer the hypothesis analysis is semantically to the context 305 in which the hypothesis 330 is found.

Combining the flows 200 and 300, it is possible to get two different two different semantic coherency scores for the ASR hypothesis 330. Different variants of these techniques may be used to produce additional semantic coherence scores. Further, machine learning approaches, such as training a neural network to rank, may be applied in order to combine these semantic coherence scores with acoustic model or language model scores, providing additional possibilities for ranking the n-best hypotheses list.

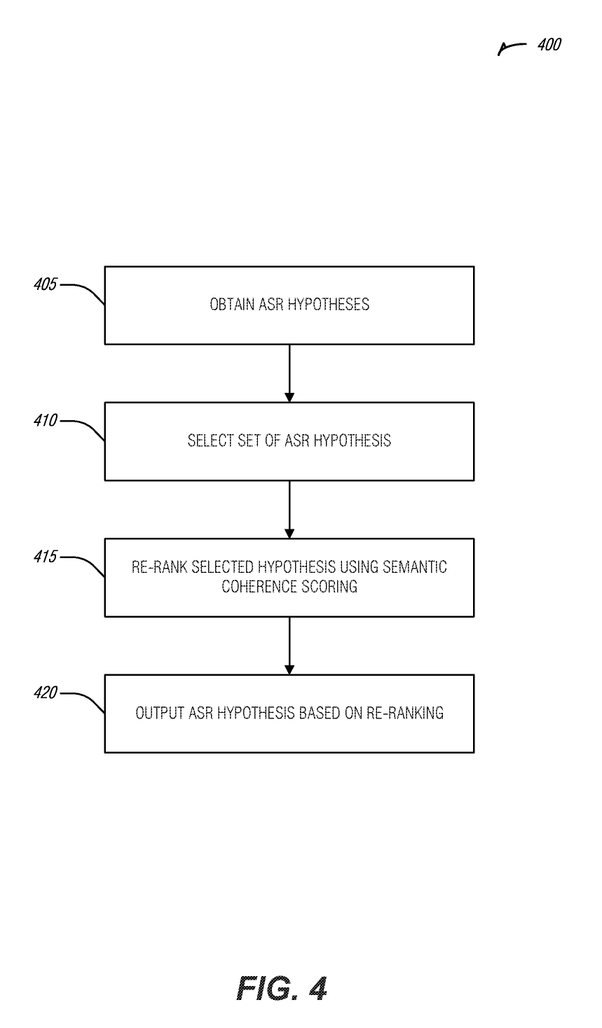

FIG. 4 illustrates an example of a method 400 for semantic word affinity ASR, according to an embodiment. The operations in the method 400 are performed on computer hardware, such as that described above with respect to FIG. 1 or below with respect to FIG. 5 (e.g., circuit sets).

At operation 405, a ranked list of ASR hypotheses is obtained, for example, by a device component. In an example, the ranked list of ASR hypothesis are ranked by at least one of an acoustical model or a statistical n-gram model. In an example, wherein a gram in the n-gram model is a word and the n refers to a proximity (e.g., an n of three indicates words within three words of a target word).

At operation 410, a set of ASR hypotheses from the list is select, for example, by the device component. In an example, the set of ASR hypotheses consist of a predefined number of highest ranked ASR hypotheses from the list, such as the top ten, top fifty, etc.

At operation 415, the set of ASR hypothesis are re-ranked (e.g., by the device component) using semantic coherence scoring between words in the ASR hypotheses. In an example, using semantic coherence scoring includes applying a semantic model to words in an ASR hypothesis to produce a respective semantic score. In an example, using semantic coherence scoring includes extracting keyphrases from the ASR hypothesis and applying the semantic model to the keyphrases to produce the respective semantic score. In an example, using semantic coherence scoring includes transforming the keyphrases to respective conical forms that adhere to the semantic model and applying the semantic model to the respective conical forms to produce the respective semantic score.

In an example, the semantic model comprises a set of word vectors. In an example, applying the semantic model includes computing a distance between word vectors of words in a hypothesis and re-ranking the hypothesis higher when the distance is small. In an example, computing the distance includes computing a cosine distance between the word vectors. In an example, applying the semantic model includes averaging distances between word vectors in keyphrases extracted from the hypothesis.

In an example, using semantic coherence scoring includes producing a context semantic score, using the semantic model, from a context of the hypothesis. In this example, the context may include a previously accepted hypothesis in a corpus that includes the hypothesis. The context semantic score and the respective semantic score may then be combined. In an example, the context includes a plurality of hypothesis selected from the corpus based on a predefined portion of speech. In an example, the predefined portion of speech is a paragraph. In an example, the predefined portion of speech is a window of sentences, such as the last five sentences, sentences within the last minute, etc. In an example, the predefined portion of speech is a conversation.

In an example, the context semantic score and the respective semantic coherence score are respective weighted sums of word vectors of the semantic model for words respectively present in the context semantic score and the respective semantic score. That is, the word vectors of the words in the context are summed and the word vectors of the words in the hypothesis are summed to respectively produce the context semantic coherence score and the semantic coherence score (for the hypothesis). In an example, combining the context semantic score and the respective semantic score (to a given hypothesis) includes computing a distance between the respective weighted sums of word vectors. In this example, a smaller distance corresponds to a higher rank for the hypothesis.

At operation 420, an ASR hypothesis from the set of ASR hypotheses with a highest re-rank is output, for example, to an application, additional language interpretation, etc. Other output forms are also possible, such as a set number of the re-ranked hypotheses.

FIG. 5 illustrates a block diagram of an example machine 500 upon which any one or more of the techniques (e.g., methodologies) discussed herein may perform. In alternative embodiments, the machine 500 may operate as a standalone device or may be connected (e.g., networked) to other machines. In a networked deployment, the machine 500 may operate in the capacity of a server machine, a client machine, or both in server-client network environments. In an example, the machine 500 may act as a peer machine in peer-to-peer (P2P) (or other distributed) network environment. The machine 500 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate by, logic or a number of components, or mechanisms. Circuit sets are a collection of circuits implemented in tangible entities that include hardware (e.g., simple circuits, gates, logic, etc.). Circuit set membership may be flexible over time and underlying hardware variability. Circuit sets include members that may, alone or in combination, perform specified operations when operating. In an example, hardware of the circuit set may be immutably designed to carry out a specific operation (e.g., hardwired). In an example, the hardware of the circuit set may include variably connected physical components (e.g., execution units, transistors, simple circuits, etc.) including a computer readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuit set in hardware via the variable connections to carry out portions of the specific operation when in operation. Accordingly, the computer readable medium is communicatively coupled to the other components of the circuit set member when the device is operating. In an example, any of the physical components may be used in more than one member of more than one circuit set. For example, under operation, execution units may be used in a first circuit of a first circuit set at one point in time and reused by a second circuit in the first circuit set, or by a third circuit in a second circuit set at a different time.

Machine (e.g., computer system) 500 may include a hardware processor 502 (e.g., a central processing unit (CPU), a graphics processing unit (GPU), a hardware processor core, or any combination thereof), a main memory 504 and a static memory 506, some or all of which may communicate with each other via an interlink (e.g., bus) 508. The machine 500 may further include a display unit 510, an alphanumeric input device 512 (e.g., a keyboard), and a user interface (UI) navigation device 514 (e.g., a mouse). In an example, the display unit 510, input device 512 and UI navigation device 514 may be a touch screen display. The machine 500 may additionally include a storage device (e.g., drive unit) 516, a signal generation device 518 (e.g., a speaker), a network interface device 520, and one or more sensors 521, such as a global positioning system (GPS) sensor, compass, accelerometer, or other sensor. The machine 500 may include an output controller 528, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 516 may include a machine readable medium 522 on which is stored one or more sets of data structures or instructions 524 (e.g., software) embodying or utilized by any one or more of the techniques or functions described herein. The instructions 524 may also reside, completely or at least partially, within the main memory 504, within static memory 506, or within the hardware processor 502 during execution thereof by the machine 500. In an example, one or any combination of the hardware processor 502, the main memory 504, the static memory 506, or the storage device 516 may constitute machine readable media.

While the machine readable medium 522 is illustrated as a single medium, the term “machine readable medium” may include a single medium or multiple media (e.g., a centralized or distributed database, and/or associated caches and servers) configured to store the one or more instructions 524.

The term “machine readable medium” may include any medium that is capable of storing, encoding, or carrying instructions for execution by the machine 500 and that cause the machine 500 to perform any one or more of the techniques of the present disclosure, or that is capable of storing, encoding or carrying data structures used by or associated with such instructions. Non-limiting machine readable medium examples may include solid-state memories, and optical and magnetic media. In an example, a massed machine readable medium comprises a machine readable medium with a plurality of particles having invariant (e.g., rest) mass. Accordingly, massed machine-readable media are not transitory propagating signals. Specific examples of massed machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 524 may further be transmitted or received over a communications network 526 using a transmission medium via the network interface device 520 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 520 may include one or more physical jacks (e.g., Ethernet, coaxial, or phone jacks) or one or more antennas to connect to the communications network 526. In an example, the network interface device 520 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 500, and includes digital or analog communications signals or other intangible medium to facilitate communication of such software.

### Additional Notes & Examples

Example 1 is a component for semantic word affinity automatic speech recognition (ASR), the component comprising: a storage device to hold a ranked list of ASR hypotheses obtained by the component; a filter to select a set of ASR hypotheses from the list, the set of ASR hypotheses consisting of a predefined number of highest ranked ASR hypotheses from the list; a processor to re-ranking the set of ASR hypothesis using semantic coherence scoring between words in the ASR hypotheses; and an interface to output a highest re-ranked ASR hypothesis from the set of ASR hypotheses.

In Example 2, the subject matter of Example 1 optionally includes wherein the ranked list of ASR hypothesis are ranked by at least one of an acoustical model or a statistical n-gram model, wherein a gram is a word.

In Example 3, the subject matter of any one or more of Examples 1-2 optionally include wherein to use semantic coherence scoring includes the processor to apply a semantic model to words in an ASR hypothesis to produce a respective semantic score.

In Example 4, the subject matter of Example 3 optionally includes wherein to use semantic coherence scoring includes the processor to extract keyphrases from the ASR hypothesis and applying the semantic model to the keyphrases to produce the respective semantic score.

In Example 5, the subject matter of Example 4 optionally includes wherein to use semantic coherence scoring includes the processor to transform the keyphrases to respective conical forms that adhere to the semantic model and applying the semantic model to the respective conical forms to produce the respective semantic score.

In Example 6, the subject matter of any one or more of Examples 3-5 optionally include wherein the semantic model comprises a set of word vectors.

In Example 7, the subject matter of Example 6 optionally includes wherein to apply the semantic model includes the processor to compute a distance between word vectors of words in a hypothesis and re-ranking the hypothesis higher when the distance is small.

In Example 8, the subject matter of Example 7 optionally includes wherein to compute the distance includes the processor to compute a cosine distance between the word vectors.

In Example 9, the subject matter of any one or more of Examples 7-8 optionally include wherein to apply the semantic model includes the processor to average distances between word vectors in keyphrases extracted from the hypothesis.

In Example 10, the subject matter of any one or more of Examples 3-9 optionally include wherein to use semantic coherence scoring includes the processor to: produce a context semantic score, using the semantic model, from a context of the hypothesis, the context including a previously accepted hypothesis in a corpus that includes the hypothesis; and combine the context semantic score and the respective semantic score.

In Example 11, the subject matter of Example 10 optionally includes wherein the context includes a plurality of hypothesis selected from the corpus based on a predefined portion of speech, the predefined portion of speech being at least one of a paragraph, a window of sentences, or a conversation.

In Example 12, the subject matter of any one or more of Examples 10-11 optionally include wherein the context semantic score and the respective semantic coherence score are respective weighted sums of word vectors of the semantic model for words respectively present in the context semantic score and the respective semantic score.

In Example 13, the subject matter of Example 12 optionally includes wherein to combine the context semantic score and the respective semantic score includes the processor to compute a distance between the respective weighted sums of word vectors, a smaller distance corresponding to a higher rank for the hypothesis.

Example 14 is a method for semantic word affinity automatic speech recognition (ASR), the method comprising: obtaining, by a device component, a ranked list of ASR hypotheses; selecting, by the device component, a set of ASR hypotheses from the list, the set of ASR hypotheses consisting of a predefined number of highest ranked ASR hypotheses from the list; re-ranking, by the device component, the set of ASR hypothesis using semantic coherence scoring between words in the ASR hypotheses; and outputting, by the device component, an ASR hypothesis from the set of ASR hypotheses with a highest re-rank.

In Example 15, the subject matter of Example 14 optionally includes wherein the ranked list of ASR hypothesis are ranked by at least one of an acoustical model or a statistical n-gram model, wherein a gram is a word.

In Example 16, the subject matter of any one or more of Examples 14-15 optionally include wherein using semantic coherence scoring includes applying a semantic model to words in an ASR hypothesis to produce a respective semantic score.

In Example 17, the subject matter of Example 16 optionally includes wherein using semantic coherence scoring includes extracting keyphrases from the ASR hypothesis and applying the semantic model to the keyphrases to produce the respective semantic score.

In Example 18, the subject matter of Example 17 optionally includes wherein using semantic coherence scoring includes transforming the keyphrases to respective conical forms that adhere to the semantic model and applying the semantic model to the respective conical forms to produce the respective semantic score.

In Example 19, the subject matter of any one or more of Examples 16-18 optionally include wherein the semantic model comprises a set of word vectors.

In Example 20, the subject matter of Example 19 optionally includes wherein applying the semantic model includes computing a distance between word vectors of words in a hypothesis and re-ranking the hypothesis higher when the distance is small.

In Example 21, the subject matter of Example 20 optionally includes wherein computing the distance includes computing a cosine distance between the word vectors.

In Example 22, the subject matter of any one or more of Examples 20-21 optionally include wherein applying the semantic model includes averaging distances between word vectors in keyphrases extracted from the hypothesis.

In Example 23, the subject matter of any one or more of Examples 16-22 optionally include wherein using semantic coherence scoring includes: producing a context semantic score, using the semantic model, from a context of the hypothesis, the context including a previously accepted hypothesis in a corpus that includes the hypothesis; and combining the context semantic score and the respective semantic score.

In Example 24, the subject matter of Example 23 optionally includes wherein the context includes a plurality of hypothesis selected from the corpus based on a predefined portion of speech, the predefined portion of speech being at least one of a paragraph, a window of sentences, or a conversation.

In Example 25, the subject matter of any one or more of Examples 23-24 optionally include wherein the context semantic score and the respective semantic coherence score are respective weighted sums of word vectors of the semantic model for words respectively present in the context semantic score and the respective semantic score.

In Example 26, the subject matter of Example 25 optionally includes wherein combining the context semantic score and the respective semantic score includes computing a distance between the respective weighted sums of word vectors, a smaller distance corresponding to a higher rank for the hypothesis.

Example 27 is at least one machine readable medium including instructions that, when executed by a machine, cause the machine to perform any of methods 14-26.

Example 28 is a system including means to perform any of methods 14-26.

Example 29 is a system for semantic word affinity automatic speech recognition (ASR), the system comprising: means for obtaining, by a device component, a ranked list of ASR hypotheses; means for selecting, by the device component, a set of ASR hypotheses from the list, the set of ASR hypotheses consisting of a predefined number of highest ranked ASR hypotheses from the list; means for re-ranking, by the device component, the set of ASR hypothesis using semantic coherence scoring between words in the ASR hypotheses; and means for outputting, by the device component, an ASR hypothesis from the set of ASR hypotheses with a highest re-rank.

In Example 30, the subject matter of Example 29 optionally includes wherein the ranked list of ASR hypothesis are ranked by at least one of an acoustical model or a statistical n-gram model, wherein a gram is a word.

In Example 31, the subject matter of any one or more of Examples 29-30 optionally include wherein using semantic coherence scoring includes means for applying a semantic model to words in an ASR hypothesis to produce a respective semantic score.

In Example 32, the subject matter of Example 31 optionally includes wherein using semantic coherence scoring includes means for extracting keyphrases from the ASR hypothesis and applying the semantic model to the keyphrases to produce the respective semantic score.

In Example 33, the subject matter of Example 32 optionally includes wherein using semantic coherence scoring includes means for transforming the keyphrases to respective conical forms that adhere to the semantic model and applying the semantic model to the respective conical forms to produce the respective semantic score.

In Example 34, the subject matter of any one or more of Examples 31-33 optionally include wherein the semantic model comprises a set of word vectors.

In Example 35, the subject matter of Example 34 optionally includes wherein applying the semantic model includes means for computing a distance between word vectors of words in a hypothesis and re-ranking the hypothesis higher when the distance is small.

In Example 36, the subject matter of Example 35 optionally includes wherein computing the distance includes means for computing a cosine distance between the word vectors.

In Example 37, the subject matter of any one or more of Examples 35-36 optionally include wherein applying the semantic model includes means for averaging distances between word vectors in keyphrases extracted from the hypothesis.

In Example 38, the subject matter of any one or more of Examples 31-37 optionally include wherein using semantic coherence scoring includes: means for producing a context semantic score, using the semantic model, from a context of the hypothesis, the context including a previously accepted hypothesis in a corpus that includes the hypothesis; and means for combining the context semantic score and the respective semantic score.

In Example 39, the subject matter of Example 38 optionally includes wherein the context includes a plurality of hypothesis selected from the corpus based on a predefined portion of speech, the predefined portion of speech being at least one of a paragraph, a window of sentences, or a conversation.

In Example 40, the subject matter of any one or more of Examples 38-39 optionally include wherein the context semantic score and the respective semantic coherence score are respective weighted sums of word vectors of the semantic model for words respectively present in the context semantic score and the respective semantic score.

In Example 41, the subject matter of Example 40 optionally includes wherein combining the context semantic score and the respective semantic score includes means for computing a distance between the respective weighted sums of word vectors, a smaller distance corresponding to a higher rank for the hypothesis.

Example 42 is at least one machine readable medium including instructions for semantic word affinity automatic speech recognition (ASR), the instructions, when executed by a machine, cause the machine to perform operations comprising: obtaining, by a device component, a ranked list of ASR hypotheses; selecting, by the device component, a set of ASR hypotheses from the list, the set of ASR hypotheses consisting of a predefined number of highest ranked ASR hypotheses from the list; re-ranking, by the device component, the set of ASR hypothesis using semantic coherence scoring between words in the ASR hypotheses; and outputting, by the device component, an ASR hypothesis from the set of ASR hypotheses with a highest re-rank.

In Example 43, the subject matter of Example 42 optionally includes wherein the ranked list of ASR hypothesis are ranked by at least one of an acoustical model or a statistical n-gram model, wherein a gram is a word.

In Example 44, the subject matter of any one or more of Examples 42-43 optionally include wherein using semantic coherence scoring includes applying a semantic model to words in an ASR hypothesis to produce a respective semantic score.

In Example 45, the subject matter of Example 44 optionally includes wherein using semantic coherence scoring includes extracting keyphrases from the ASR hypothesis and applying the semantic model to the keyphrases to produce the respective semantic score.

In Example 46, the subject matter of Example 45 optionally includes wherein using semantic coherence scoring includes transforming the keyphrases to respective conical forms that adhere to the semantic model and applying the semantic model to the respective conical forms to produce the respective semantic score.

In Example 47, the subject matter of any one or more of Examples 44-46 optionally include wherein the semantic model comprises a set of word vectors.

In Example 48, the subject matter of Example 47 optionally includes wherein applying the semantic model includes computing a distance between word vectors of words in a hypothesis and re-ranking the hypothesis higher when the distance is small.

In Example 49, the subject matter of Example 48 optionally includes wherein computing the distance includes computing a cosine distance between the word vectors.

In Example 50, the subject matter of any one or more of Examples 48-49 optionally include wherein applying the semantic model includes averaging distances between word vectors in keyphrases extracted from the hypothesis.

In Example 51, the subject matter of any one or more of Examples 44-50 optionally include wherein using semantic coherence scoring includes: producing a context semantic score, using the semantic model, from a context of the hypothesis, the context including a previously accepted hypothesis in a corpus that includes the hypothesis; and combining the context semantic score and the respective semantic score.

In Example 52, the subject matter of Example 51 optionally includes wherein the context includes a plurality of hypothesis selected from the corpus based on a predefined portion of speech, the predefined portion of speech being at least one of a paragraph, a window of sentences, or a conversation.

In Example 53, the subject matter of any one or more of Examples 51-52 optionally include wherein the context semantic score and the respective semantic coherence score are respective weighted sums of word vectors of the semantic model for words respectively present in the context semantic score and the respective semantic score.

In Example 54, the subject matter of Example 53 optionally includes wherein combining the context semantic score and the respective semantic score includes computing a distance between the respective weighted sums of word vectors, a smaller distance corresponding to a higher rank for the hypothesis.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the embodiments should be determined with reference to the appended claims, along with the full scope of equivalents to which such claims are entitled.

1. A component for semantic word affinity automatic speech recognition (ASR), the component comprising:
a storage device to hold a ranked list of ASR hypotheses obtained by the component;
a filter to select a set of ASR hypotheses from the list, the set of ASR hypotheses consisting of a predefined number of highest ranked ASR hypotheses from the list;
a processor to re-rank the set of ASR hypothesis using semantic coherence scoring between words in the ASR hypotheses, wherein to use semantic coherence scoring includes the processor to apply a semantic model to words in an ASR hypothesis to produce a respective semantic score, wherein the semantic model comprises a set of word vectors, wherein to apply the semantic model includes the processor to compute a distance between word vectors of words in a hypothesis and re-ranking the hypothesis higher when the distance s small; and
an interface to output a highest re-ranked ASR hypothesis from the set of ASR hypotheses.

2-4. (canceled)

5. The component of claim 1, wherein to apply the semantic model includes the processor to average distances between word vectors in keyphrases extracted from the hypothesis.

6. The component of claim 1, wherein to use semantic coherence scoring includes the processor to:
produce a context semantic score, using the semantic model, from a context of the hypothesis, the context including a previously accepted hypothesis in a corpus that includes the hypothesis; and
combine the context semantic score and the respective semantic score.

7. The component of claim 6, wherein the context semantic score and the respective semantic coherence score are respective weighted sums of word vectors of the semantic model for words respectively present in the context semantic score and the respective semantic score.

8. The component of claim 7, wherein to combine the context semantic score and the respective semantic score includes the processor to compute a distance between the respective weighted sums of word vectors, a smaller distance corresponding to a higher rank for the hypothesis.

9. A method for semantic word affinity automatic speech recognition (ASR), the method comprising:
obtaining, by a device component, a ranked list of ASR hypotheses;
selecting, by the device component, a set of ASR hypotheses from the list, the set of ASR hypotheses consisting of a predefined number of highest ranked ASR hypotheses from the list;
re-ranking by the device component, the set of ASR hypothesis using semantic coherence scoring between words in the ASR hypotheses, wherein using semantic coherence scoring includes applying a semantic model to words in an ASR hypothesis to produce a respective semantic score, wherein the semantic model comprises a set of word vectors, wherein applying the semantic model includes computing a distance between word vectors of words in a hypothesis and re-ranking the hypothesis higher when the distance is small; and
outputting, by the device component, an ASR hypothesis from the set of ASR hypotheses with a highest re-rank.

10-12. (canceled)

13. The method of claim 9, wherein applying the semantic model includes averaging distances between word vectors in keyphrases extracted from the hypothesis.

14. The method of claim 9, wherein using semantic coherence scoring includes:
producing a context semantic score, using the semantic model, from a context of the hypothesis, the context including a previously accepted hypothesis in a corpus that includes the hypothesis; and
combining the context semantic score and the respective semantic score.

15. The method of claim 14, wherein the context semantic score and the respective semantic coherence score are respective weighted sums of word vectors of the semantic model for words respectively present in the context semantic score and the respective semantic score.

16. The method of claim 15, wherein combining the context semantic score and the respective semantic score includes computing a distance between the respective weighted sums of word vectors, a smaller distance corresponding to a higher rank for the hypothesis.

17. At least one non-transitory machine readable medium including instructions for semantic word affinity automatic speech recognition (ASR), the instructions, when executed by a machine, cause the machine to perform operations comprising:
obtaining, by a device component, a ranked list of ASR hypotheses;
selecting, by the device component, a set of ASR hypotheses from the list, the set of ASR hypotheses consisting of a predefined number of highest ranked ASR hypotheses from the list;
re-ranking by the device component, the set of ASR hypothesis using semantic coherence scoring between words in the ASR hypotheses, wherein using semantic coherence scoring includes applying a semantic model to words in an ASR hypothesis to produce a respective semantic score, wherein the semantic model comprises a set of word vectors, wherein applying the semantic model includes computing a distance between word vectors of words in a hypothesis and re-ranking the hypothesis higher when the distance is small; and
outputting, by the device component, an ASR hypothesis from the set of ASR hypotheses with a highest re-rank.

18-20. (canceled)

21. The machine readable medium of claim 17, wherein applying the semantic model includes averaging distances between word vectors in keyphrases extracted from the hypothesis.

22. The machine readable medium of claim 17, wherein using semantic coherence scoring includes:
producing a context semantic score, using the semantic model, from a context of the hypothesis, the context including a previously accepted hypothesis in a corpus that includes the hypothesis; and
combining the context semantic score and the respective semantic score.

23. The machine readable medium of claim 22, wherein the context semantic score and the respective semantic coherence score are respective weighted sums of word vectors of the semantic model for words respectively present in the context semantic score and the respective semantic score.

24. The machine readable medium of claim 23, wherein combining the context semantic score and the respective semantic score includes computing a distance between the respective weighted sums of word vectors, a smaller distance corresponding to a higher rank for the hypothesis.

25. The component of claim 1, wherein the ranked list of ASR hypothesis are ranked by at least one of an acoustical model or a statistical n-gram model, wherein a gram is a word.

26. The component of claim 1, wherein to compute the distance includes the processor to compute a cosine distance between the word vectors.

27. The component of claim 6, wherein the context includes a plurality of hypothesis selected from the corpus based on a predefined portion of speech, the predefined portion of speech being at least one of a paragraph, a window of sentences, or a conversation.

28. The method of claim 9, wherein the ranked list of ASR hypothesis are ranked by at east one of an acoustical model or a statistical n-gram model, wherein a gram is a word.

29. The method of claim 9, wherein computing the distance includes computing a cosine distance between the word vectors.

30. The method of claim 14, wherein the context includes a plurality of hypothesis selected from the corpus based on a predefined portion of speech, the predefined portion of speech being at least one of a paragraph, a window of sentences, or a conversation.

31. The machine readable medium of claim 17, wherein the ranked list of ASR hypothesis are ranked by at least one of an acoustical model or a statistical n-gram model, wherein a grain is a word.

32. The machine readable medium of claim 17, wherein computing the distance includes computing a cosine distance between the word vectors.

33. The machine readable medium of claim 22, wherein the context includes a plurality of hypothesis selected from the corpus based on a predefined portion of speech, the predefined portion of speech being at least one of a paragraph, a window of sentences, or a conversation.
